(19) United States
(12) Patent Application Publication
(10) Pub. No.: US 2003/0115548 A1
(43) Pub. Date: Jun. 19, 2003

(54) Generating class library to represent messages described in a structured language schema

(75) Inventor: David O. Melgar, Raleigh, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/016,933

(22) Filed: Dec. 14, 2001

(51) Int. Cl. G06F 17/24

(52) U.S. Cl. 715/513

(57) ABSTRACT

Techniques are disclosed for programmatically generating class libraries to represent the messages which may be sent/received according to specifications provided in a structured language message definition schema (or its equivalent, alternatively, such as a Document Type Definition or “DTD”). The disclosed techniques are very flexible, and are not limited to a single output programming language. Instead, a template-driven approach can be used to guide the generation process, where templates for multiple programming languages may be used to generate different versions of a class library, one for each programming language. The generation process can also be directed by rules specified in a rules file. The disclosed techniques can be used to generate class libraries for web services which have a service interface defined using only a schema reference. Migration can be evaluated programmatically, enabling much easier resolution of migration issues than is possible using prior art manual migration techniques.

### BACKGROUND OF THE INVENTION

1. Field of the Invention

The present invention relates to computer software, and deals more particularly with techniques for programmatically generating class libraries to represent the messages which may be sent/received according to specifications provided in a structured language message definition schema (or its equivalent, alternatively, such as a Document Type Definition or “DTD”).

2. Description of the Related Art

The popularity of distributed computing networks and network computing has increased tremendously in recent years, due in large part to growing business and consumer use of the public Internet and the subset thereof known as the “World Wide Web” (or simply “Web”). Other types of distributed computing networks, such as corporate intranets and extranets, are also increasingly popular. As solutions providers focus on delivering improved Web-based computing, many of the solutions which are developed are adaptable to other distributed computing environments. Thus, references herein to the Internet and Web are for purposes of illustration and not of limitation.

Use of structured documents encoded in a structured markup language has become increasingly prevalent in recent years as a means for exchanging information between computers in distributed computing networks. In addition, many of today's software products are written to produce and consume information which is represented using these types of structured documents. The Extensible Markup Language, or “XML”, for example, is a markup language which has proven to be extremely popular for encoding structured documents for exchange between parties (and also for describing structured data). XML is very well suited for encoding document content covering a broad spectrum. XML has also been used as a foundation for many other derivative markup languages, such as the Wireless Markup Language (“WML”), VoiceXML, MathML, and so forth. (For more information on XML, refer to “Extensible Markup Language (XML), W3C Recommendation Feb. 10, 1998” which is available on the World Wide Web at http://www.w3.org/TR/1998/REC-xml-19980210. WML information may be found in “Wireless Application Protocol Wireless Markup Language Specification Version 1.1 (WAP WML), Proposed Version Feb. 3, 1999”, which is available on the Web at http://www.wapforum.org.)

For the early uses of structured documents, and in particular for XML version 1.0, a Document Type Definition (“DTD”) was used for specifying the grammar for a particular structured document. That is, a DTD specifies the set of allowable markup tags, where this set indicates the permissible elements and attributes to be used in the document. In more recent years, a “schema” is commonly used instead of a DTD. A schema contains information similar to that in a DTD, but is much more functionally rich, and attempts to specify more requirements for the structured documents which adhere to it. As stated by the World Wide Web Consortium (“W3C”), “XML Schemas express shared vocabularies and allow machines to carry out rules made by people. They provide a means for defining the structure, content and semantics of XML documents.”. (See http://www.w3.org/XML/Schema.) Several documents discussing schemas may be found on the W3C Web site (http://www.w3.org), including “XML Schema Part 0: Primer, W3C Recommendation, May 2, 2001”; “XML Schema Part 1: Structures, W3C Recommendation May 2, 2001∞; “XML Schema Part 2: Datatypes, W3C Recommendation May 2, 2001”; and “XML Schema: Formal Description, W3C Working Draft, March 20, 2001”. Schema syntax has been undergoing change as the schema concept evolves. Examples and corresponding descriptions provided herein are based on a schema version as defined at locator http://www.w3.org/1999/XMLSchema.dtd, the content of which is dated Apr. 28, 2000.

When programmers develop programs that transmit and receive messages using XML documents, a class library is usually created to represent these XML messages. (That is, the class library contains code to create XML request messages and to interpret XML response messages.) This class library becomes the majority of an applications programming interface (“API”) to interact with the XML messages. A great deal of effort is typically expended creating such a class library. Creating this library manually has a number of disadvantages. As one example, a large programming effort is required for initially creating the library. Another disadvantage is that the quality of the created code tends to be low. One reason for this is that, by its nature, the class library code tends to contain many areas that are very similar except for changes in the names of things. (For example, each message attribute needs both a setter and a getter method, and there may be a very large number of attributes to account for.) The manual code creation process is therefore very tedious and may be unchallenging for the programmer, which in turn increases the likelihood of oversights, typographical errors, and missed edits where duplicated code should have been modified for a new use. An additional disadvantage is that the resulting class library is very tightly bound to the XML message format being represented. That is, the code in the class library is manually created to match the defined message formats. However, these formats may change and evolve over time, creating a maintenance headache for the person responsible for keeping the class library synchronized with the message format definitions. Upgrading the library introduces the same problems over again, i.e. low quality, error-prone changes that are very time-consuming to make.

It is desirable to provide automated generation techniques that create class libraries from XML message definitions, thereby avoiding the problems discussed above.

### SUMMARY OF THE INVENTION

An object of the present invention is to provide techniques for programmatically generating class libraries from structured language definitions.

Another object of the present invention is to provide techniques for programmatically generating class libraries from specifications provided using schemas.

A further object of the present invention is to enable efficiently generating multiple class libraries for a particular structured language definition, where the multiple libraries are for use with different programming languages.

Yet another object of the present invention is to define a template-driven class library generation technique.

It is another object of the present invention to provide a class library generation process which programmatically provides migration or “versioning” support to handle changes that occur to a structured language specification.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for programmatically generating a class library to represent messages described in a structured language specification. In preferred embodiments, this technique comprises: parsing an input structured language specification encoded in a structured markup language; identifying selected aspects of the input structured language specification during the parsing; and creating output code for the identified selected aspects by applying previously-specified operations, wherein the previously-specified operations create programming language statements in a target programming language such that the created output code comprises a class library in the target programming language.

In preferred embodiments, the input structured language specification is a schema and the structured markup language is XML. The selected aspects may comprise presence of one or more of (1) elements and (2) attributes encoded in the structured markup language, as well as presence of child elements and whether the attributes and child elements are required.

In some embodiments, the selected aspects and the previously-specified operations are specified in a template, and this template is adapted to creating the output code in the target programming language. Optionally, the technique may further comprise substituting a different template to create the output code for the input structured language specification in a different target programming language.

The target programming language may be an object-oriented programming language, in which case wherein the previously-specified operations may comprise: creating output code for creating objects which represent elements of the input structured language specification; creating output code for setting value in, and retrieving values from, the created objects; creating output code for sending a message whose contents reflect one of the created objects; creating output code for sending a message whose contents reflect the values retrieved from one of the created objects; and/or creating output code for receiving a message and using contents of the received message for setting the value in one of the created objects.

Optionally, rules may be used to influence the output code creation. For example, one of the rules may specify where the created output code should be stored. or a name for the class library. One or more of the rules might specify special processing to override the output code creation for particular ones of the aspects.

The programmatic generation technique may be invoked during processing of a web service which is specified using a reference to the input structured language specification. This reference may be specified as a Uniform Resource Locator in a Web Services Definition Language document.

In an optional enhancement, migration logic may be programmatically generated for the input structured language specification. This enhancement preferably further comprises: repeating the parsing process for parsing a newer version of the input structured language specification; comparing the parsed input structured language specification to the parsed newer version; identifying, during the comparison, elements and attributes which are present in the input structured language specification but which are not present in the newer version; and modifying the template to account for the identified elements and attributes, after which the modified template is used by the identifying and creating processes. The modifications may be performed by a human, or may be performed programmatically.

The present invention may also be used advantageously in methods of doing business, for example by providing improved class-generation services for clients who might subscribe to such a service for a fee.

The present invention will now be described with reference to the following drawings, in which like reference numbers denote the same element throughout.

### BRIEF DESCRIPTION OF THE DRAWINGS

FIG. 1 illustrates the components and process involved when using preferred embodiments of the present invention;

FIG. 2 depicts a fragment of a sample schema for which code may be generated, using techniques of the present invention;

FIG. 3 shows sample rules that may optionally be used to tailor the class library generation process, according to preferred embodiments;

FIGS. 4A and 4B show sample output class library code generated for the input schema of FIG. 2 and the sample rules of FIG. 3;

FIG. 5 shows a code fragment from an application program, illustrating how the classes and methods of the class library in FIGS. 4A and 4B may be used to send and receive messages;

FIG. 6 shows another sample schema fragment, where this sample is chosen to illustrate more complex features than the sample in FIG. 2;

FIGS. 7A through 7F illustrate a sample template, and are used to describe how templates guide the class library generator code of preferred embodiments;

FIGS. 8A through 8I illustrate another sample output class library, corresponding to the more complex input schema in FIG. 6;

FIGS. 9A and 9B provide flowcharts depicting logic which may be used to implement preferred embodiments of the present invention; and

FIG. 10 provides a flowchart depicting logic which may be used to implement an optional aspect of the present invention in which migration of the messaging specification is addressed.

### DESCRIPTION OF PREFERRED EMBODIMENTS

The present invention provides techniques for programmatically generating class libraries for messages which are described by a structured definition. As will be described in detail herein, preferred embodiments programmatically generate a class library representing the messages which can be sent and received according to the information specified in an XML schema. For purposes of illustration but not of limitation, preferred embodiments of the present invention are described in terms of elements which are defined according to an XML schema. However, the inventive concepts disclosed herein may be adapted to messages which are defined using other structured markup languages and/or which are defined using other definitional approaches (such as DTDs). Thus, references herein to “XML” and “schema” are intended to encompass similar languages and definitions.

Before discussing how the preferred embodiments operate, a number of advantages of the present invention over prior art techniques will now be described. A key advantage is that the effort required to initially create the class library is greatly reduced, typically by orders of magnitude, as contrasted to a manual code generation approach. Another advantage is that the quality of the resulting code is very high, because the tedium for the human programmer has been removed by substituting a programmatic generation process. In fact, the inherent redundancy which increases the likelihood of errors in a manually-generated library serves to reduce the likelihood of errors in the programmatically-generated library. Furthermore, the resulting class library can be generated as often as desired, in order to deal with evolution and changes to the underlying XML messages. This removes the heavy maintenance burden of keeping the class library synchronized with the current message specification.

Preferred embodiments use a template-driven approach to class library generation. In the context of the present invention, a template may be thought of as a pattern that specifies guidance for the code generation process. These templates, which will be described in detail below, may be used to guide the code generator in language-specific ways. For example, one template might provide guidance for generating code for a particular input schema to create a class library in the C++ programming language, while another template might provide guidance for generating code for the same input schema to create a class library in the Java™ programming language. (“Java” is a trademark of Sun Microsystems, Inc.) In this manner, a number of efficiencies are gained. As will be obvious, the effort required for generating class library code for more than one programming language is greatly reduced over a manual process that is tedious and error-prone even when only one language needs to be accommodated. The generated code is much more consistent as well when using a template-driven approach, which will tend to make the task of supporting multiple library versions much easier. Changes or additions to class library logic can occur in a central point, namely the template, making enhancement of the library to account for a revised message specification much easier and more reasonable to implement. In addition, the development and testing efforts are greatly reduced, as only a single template needs to be written and tested, and can then be re-used with multiple schemas for generating multiple class libraries. Fixing coding errors is also simplified, as any errors in a template only need to be corrected in the template itself, after which a corrected class library can be easily generated.

It should be noted, however, that the inventive techniques of the present invention do not strictly require use of templates. Therefore, alternative embodiments may incorporate the features of the templates into the code generator, if desired for a particular implementation. A disadvantage of this alternative approach is that the code generator becomes adapted for creation of code in a particular programming language. This is the approach which has typically been taken in prior art class library generators, which simply create code directly from an XML schema for a particular target programming language.

Optionally, a set of generation rules may be used to tailor the class library generation process. For example, a rules file may be used to specify the output directory to be used when creating a class library, the package name to be used for the library, and so forth. (Alternatively, this type of information may be specified in other ways, including prompting a user to provide the information into a window during the code generation process, hard-coding the information into the generator, augmenting the template with a specification of this information, and so forth.)

The techniques of the present invention also facilitate enhancements to the code generation process that would be very time-consuming and expensive to provide using prior art approaches. Because a program is used to generate the class library, logic within this program (and/or within a template) can be enhanced to continue to provide additional capabilities such as migration logic. Migration logic can be programmatically generated to handle compatibility issues between multiple versions of the XML schema being represented (as will be further described below). And as discussed above, templates can be used to support class library generation in multiple languages, such as Java and C++, as well as other languages such as C#. Therefore, the code generation process can be quickly adapted to create class libraries in new target languages when the need arises.

Furthermore, the techniques of the present invention enable class generation to occur dynamically, as part of other processes. An example of this usage is when processing a Web Services Definition Language (“WSDU”) specification. The WSDL specification can be read and analyzed to determine if it references an XML schema for its service definition. If so, then a class library can be programmatically generated using the techniques of the present invention, where a class will be generated from the WSDL to represent a client proxy. (This client proxy will contain a method to invoke the service, passing in the objects that represent allowable top-level elements from the schema.) While this is one example of using the present invention as part of another process to dynamically generate a class library, other uses may be envisaged once the inventive techniques disclosed herein are known, including uses which will provide or enhance a programming development environment.

The class library generated for use with web services may be used advantageously by a programmer (for example, via a code development tool which makes the generated class library available) for building the code for a web service or client, given a WSDL description and the schema for allowable messages.

U.S. Pat. No. 6,083,276, which is titled “Creating and configuring component-based applications using a text-based descriptive attribute grammar”, discloses a technique for generating a class library which represents an XML schema, based on a set of rules. The code generator disclosed therein may be run against multiple schemas to generate multiple class libraries (i.e. one class library per schema), but there are no teachings in this prior art approach for generating class libraries in multiple languages for a single schema. Furthermore, this prior art approach does not teach use of templates, performing the generation in the context of another process (and in particular, within web services operations), or support for migration, all of which are disclosed herein.

Before discussing embodiments of the present invention in more detail, the web services environment will now be discussed to provide background information and to illustrate how the present invention may be used advantageously in this environment.

The so-called “web services” initiative is an area where advances are being made in distributed computing. This initiative is also commonly referred to as the “service-oriented architecture” for distributed computing. Web services are a rapidly emerging technology for distributed application integration in the Internet. In general, a “web service” is an interface that describes a collection of network-accessible operations. Web services fulfill a specific task or a set of tasks. They may work with one or more other web services in an interoperable manner to carry out their part of a complex workflow or a business transaction. For example, completing a complex purchase order transaction may require automated interaction between an order placement service (i.e. order placement software) at the ordering business and an order fulfillment service at one or more of its business partners.

Many industry experts consider the service-oriented web services initiative to be the next evolutionary phase of the Internet. With web services, distributed network access to software will become widely available for program-to-program operation, without requiring intervention from humans.

To use a web service which may be remotely located, a human program developer may learn of a particular service and design one or more programs or program components to interact with that service. Optionally, a provider of a particular web service may advertise the service for network-accessible use by publishing the service to a network-accessible registry. At run-time, a service provider for the service may then be located dynamically. This may be done by querying the registry for the particular service of interest, in order to find out which providers offer that service, and an address where the service is available from a provider. (Or, the service provider might be known without using dynamic discovery.) Alternatively, rather than having a priori knowledge of a service interface and dynamically discovering a service provider, registries are also intended to support dynamic discovery of a service interface. In this case, the program developer may design his program(s) or program component(s) without knowledge of the precise interface that will be used. This dynamic service interface discovery process is designed to occur programmatically, without human intervention, such that a service requester can search for a particular service and make use of that service dynamically, at run-time. (This latter approach, however, is beyond the scope of the present invention, and thus will not be discussed in further detail herein.)

Web services work is being built on a number of standards, including HTTP (“Hypertext Transfer Protocol”), SOAP (“Simple Object Access Protocol”) and/or XML (“Extensible Markup Language”) Protocol, WSDL (“Web Services Description Language”), and UDDI (“Universal Description, Discovery, and Integration”). HTTP is commonly used to exchange messages over TCP/IP (“Transmission Control Protocol/Internet Protocol”) networks such as the Internet. SOAP is an XML-based protocol used to send messages for invoking methods in a distributed environment. XML Protocol is an evolving specification of the World Wide Web Consortium (“W3C”) for an application-layer transfer protocol that will enable application-to-application messaging, and may converge with SOAP. WSDL is an XML format for describing distributed network services. UDDI is an XML-based registry technique with which businesses may list their services and with which service requesters may find businesses providing particular services. (For more information on SOAP, refer to “Simple Object Access Protocol (SOAP) 1.1, W3C Note May 8, 2000”, which is available on the Internet at http://www.w3.org/TR/2000/NOTE-SOAP-20000508. See http://www.w3.org/2000/xp for more information on XML Protocol and the creation of an XML Protocol standard. The WSDL specification is titled “Web Services Description Language (WSDL) 1.1, W3C Note Mar. 15, 2001”, and may be found on the Internet at http://www.w3.org/TR/2001/NOTE-wsdl-20010315. For more information on UDDI, refer to the UDDI specification which is entitled “UDDI Version 2.0 API Specification, UDDI Open Draft Specification Jun. 8, 2001”, and which can be found on the Internet at http://www.uddi.org/specification.html. HTTP is described in Request For Comments (“RFC”) 2616 from the Internet Engineering Task Force, titled “Hypertext Transfer Protocol—HTTP/1.1” (June 1999).)

Application integration using these open standards requires several steps. The interface to a web service must be described, including the method name(s) with which the service is invoked, the method's input and output parameters and their data types, and so forth. WSDL documents are commonly used to provide this information. When a web service is to be advertised in a network-accessible registry, the WSDL document for that service may be transmitted using a UDDI “publish” operation to a registry implemented according to the UDDI specification. The service's interface may also be made known in other ways. For example, the WSDL document might be sent to a programmer by e-mail, or a paper copy might be provided. As another example, the programmer might simply learn a service's interface by having access to a schema which describes messages that can be sent to and received from the service.

When WSDL is used to define a web service interface, the interface can be defined in terms of SOAP messages that are based on an XML schema. WSDL allows a web service to be defined using either (1) a Remote Procedure Call (“RPC”) communications approach, where the service interface is set out in the WSDL document, or (2) a “messaging-style” or “document-style” protocol, where the service interface is specified simply as a reference to an XML schema. (For example, the reference is typically specified as the Uniform Resource Identifier, or “URI”, where the schema is stored.) Tools exist in the prior art to automatically generate stub code to interact with SOAP services that use the RPC style of communication, whereby the stub code is compiled as part of the program from which the request messages are sent (and in which response messages are received). The stub code acts as an interface between the locally-executing program and the remote service, often referred to as a “client proxy”, where this stub code makes the remote invocation transparent to the local program. RPC-style message invocation is well known in the art, and techniques for using it with WSDL-described services are straightforward. To the best of the present inventor's knowledge and belief, on the other hand, the messaging or document style processing (hereinafter referred to as “document-style processing”) is not addressed by prior art tools—nor is it straightforward. The techniques of the present invention provide a solution for document-style processing, whereby a class library can be generated for a web service that is referenced in the WSDL document. These techniques optionally may also be tied in with the prior art RPC-style tools to automatically generate a class library representing the message schema referenced from the WSDL specification in order to allow easy creation of messages as part of the generated stubs.

Turning now to the figures, embodiments of the present invention will be described.

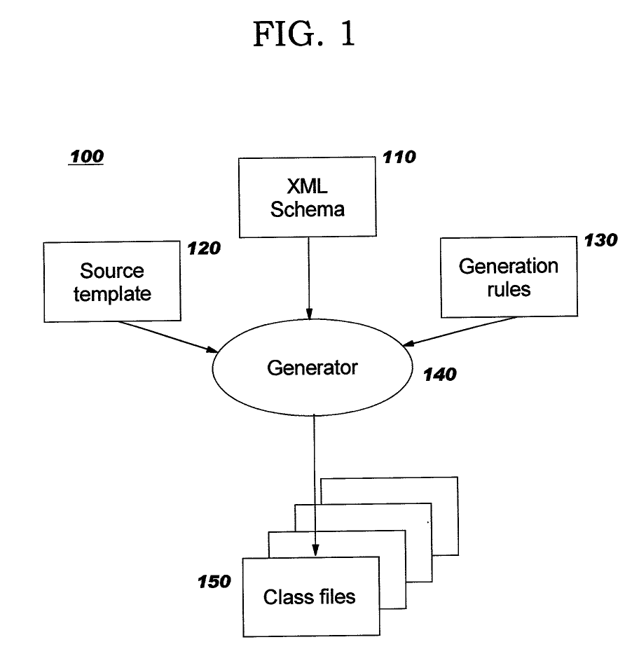

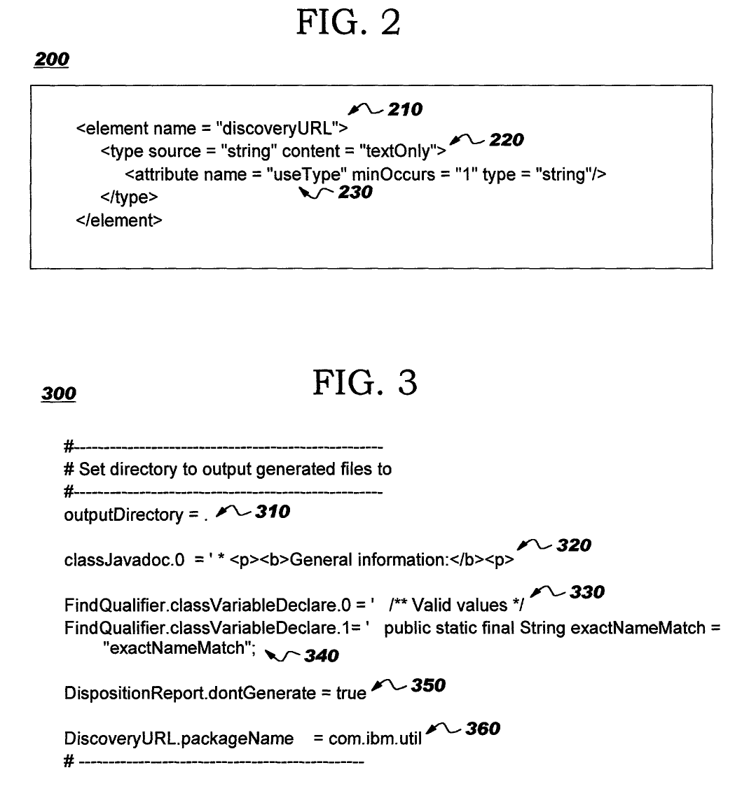

FIG. 1 depicts components and process involved in operation of preferred embodiments of the present invention. An XML schema 110, optionally a source template 120, and optionally a set of generation rules 130 are input to a class library generator 140, the output of which is one or more class files 150. These components and this process will now be described in detail with reference to FIGS. 2 though 10.

FIG. 2 shows a simple fragment 200 from a sample XML input schema. This definition specifies the valid syntax for an element named “discoveryURL” (see element 210). As can be seen with reference to the <type> element, “discoveryURL” is a string type, and its contents are defined as “textOnly” (indicating that it does not allow any child elements). The discoveryURL has a single attribute, which is named “useType”. This attribute is required, by virtue of having its “minOccurs” (i.e. minimum number of occurrences) value set to “1”. The useType is also of string type.

A programmer might wish to send a request message using this discoveryURL element to learn the Uniform Resource Locator (“URL”) associated with a particular service provider or perhaps to learn the URL of some previously-stored static content. The processing of the present invention generates a class library that includes code for setting the parameters of such a message (according to the messaging interface defined in the schema), issuing the message, receiving its response, and parsing the response (again, according to the message interface in the schema) to locate the returned information.

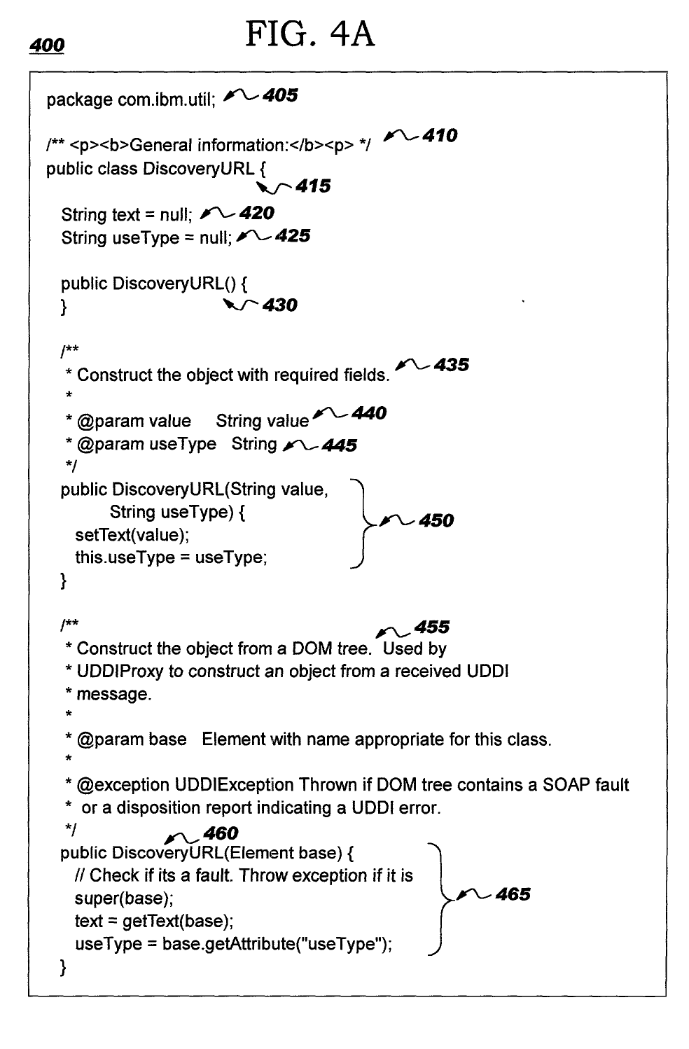

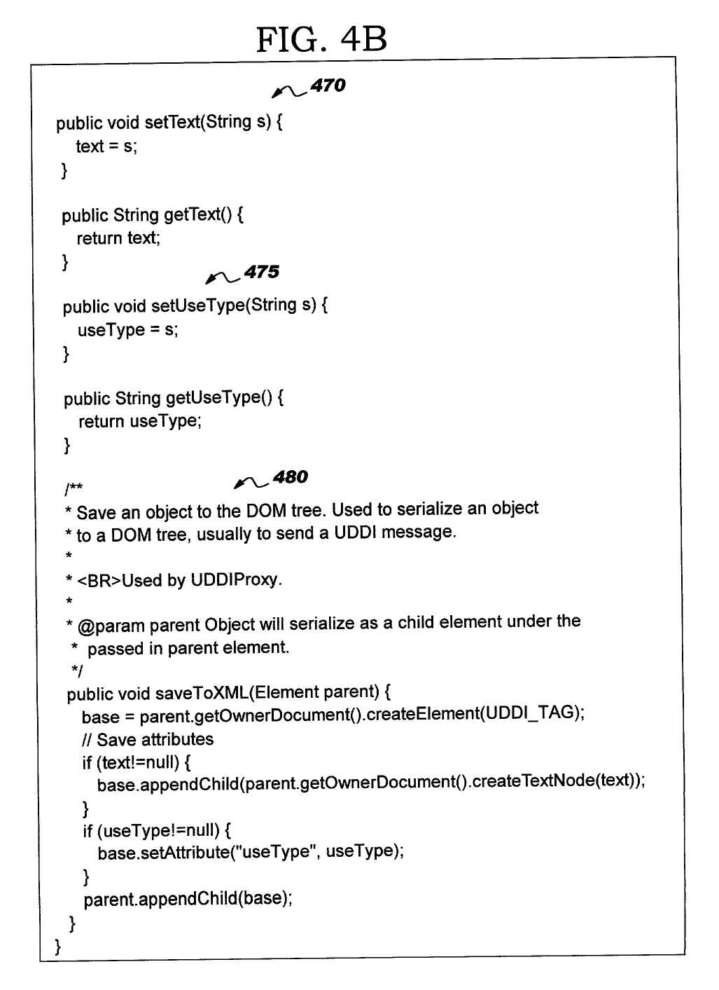

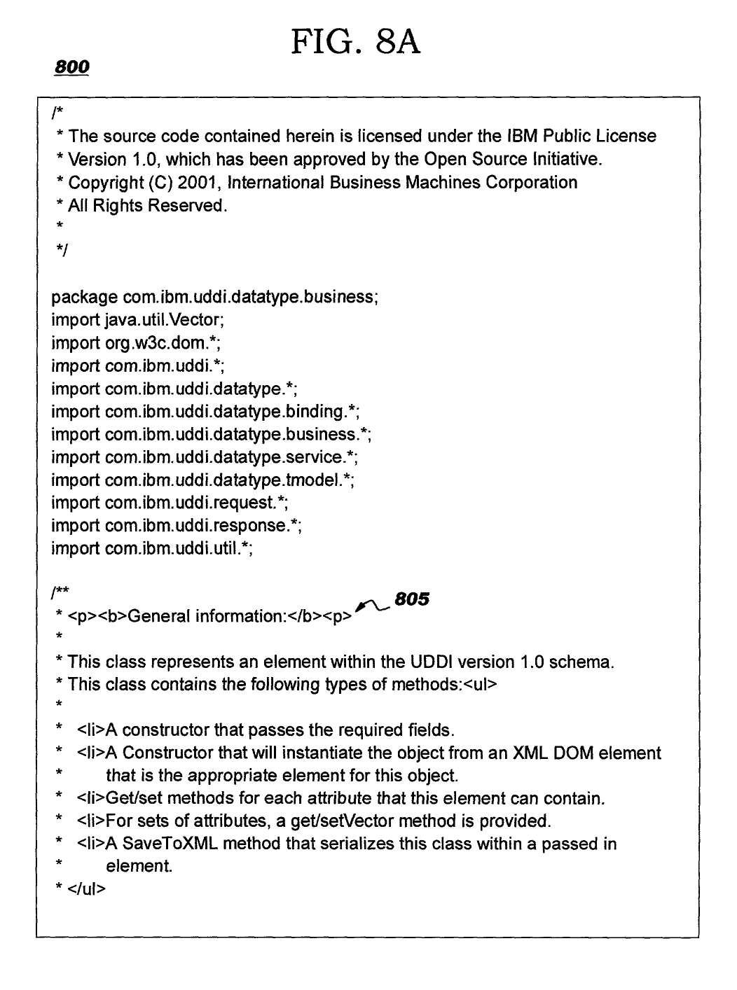

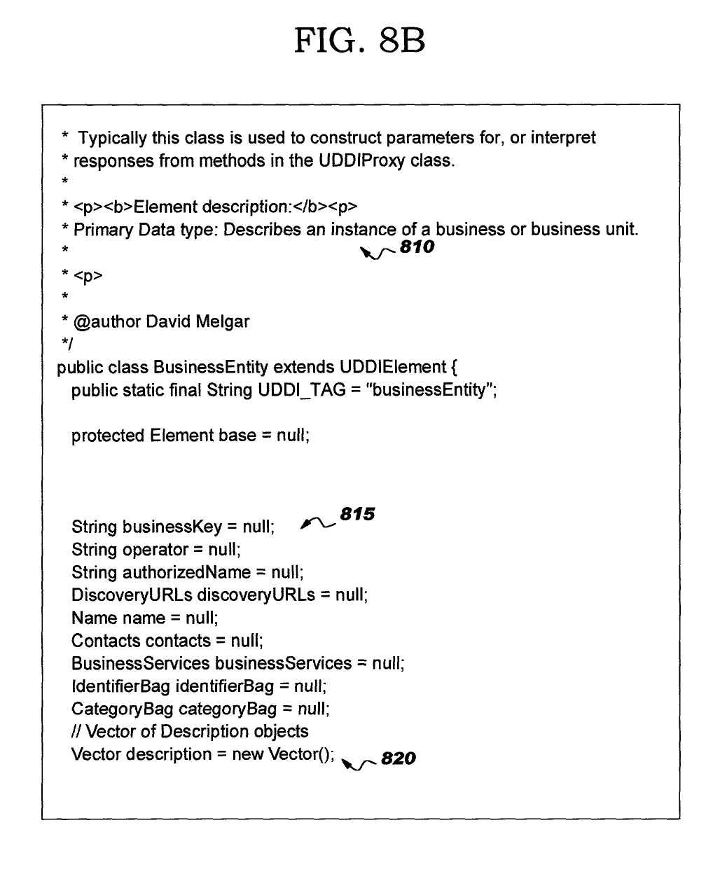

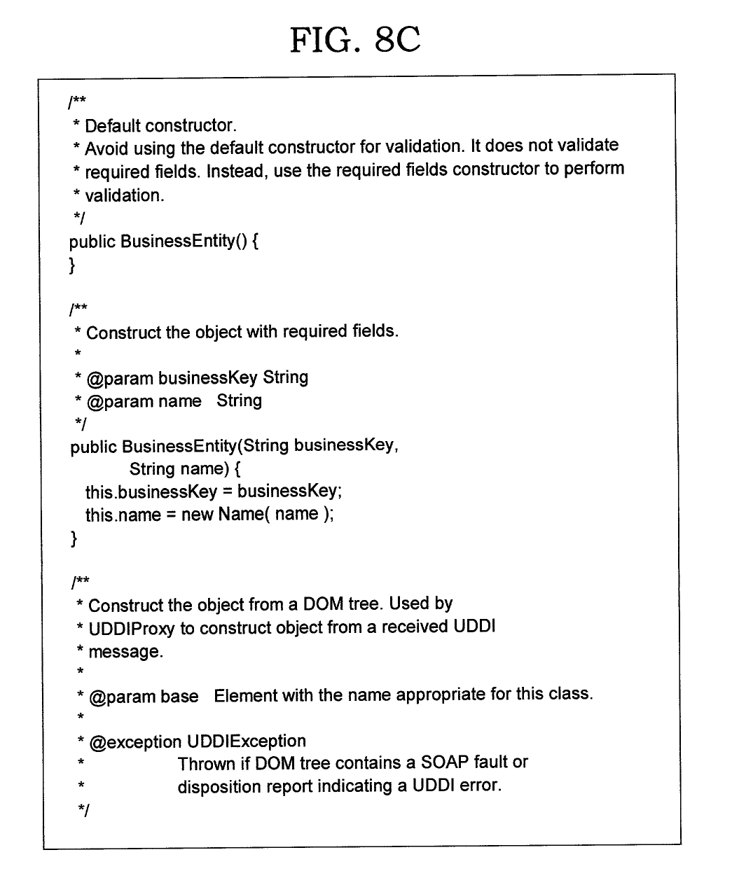

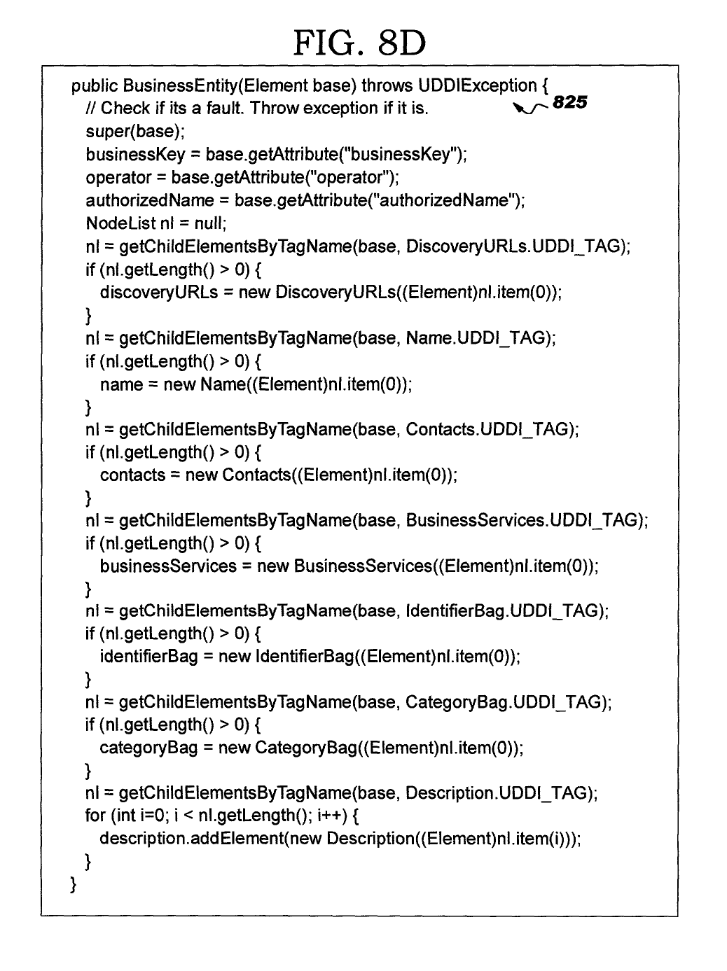

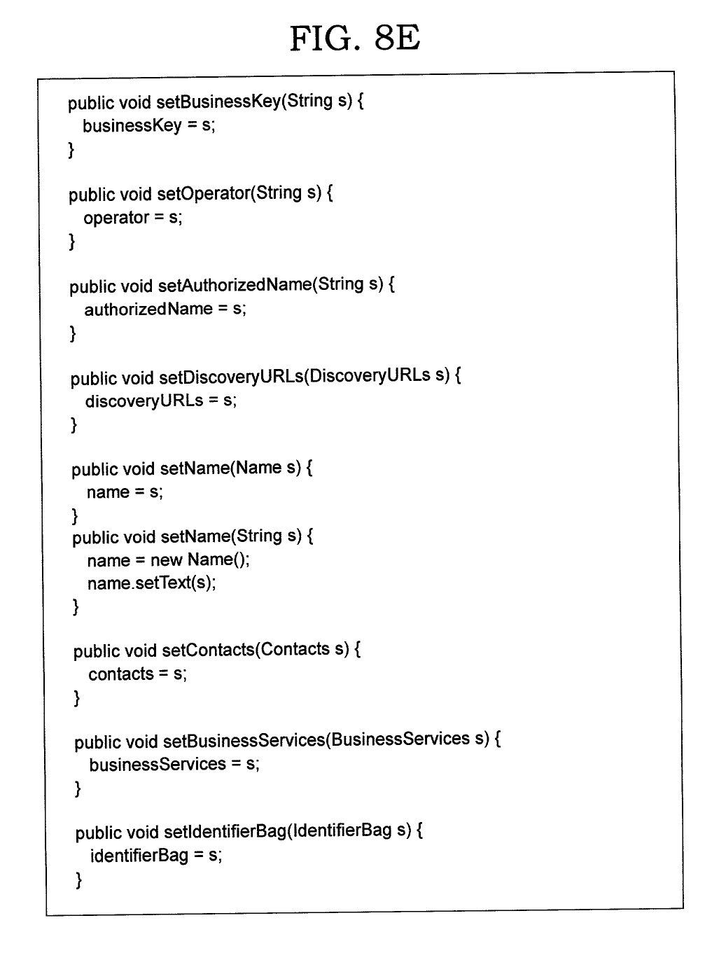

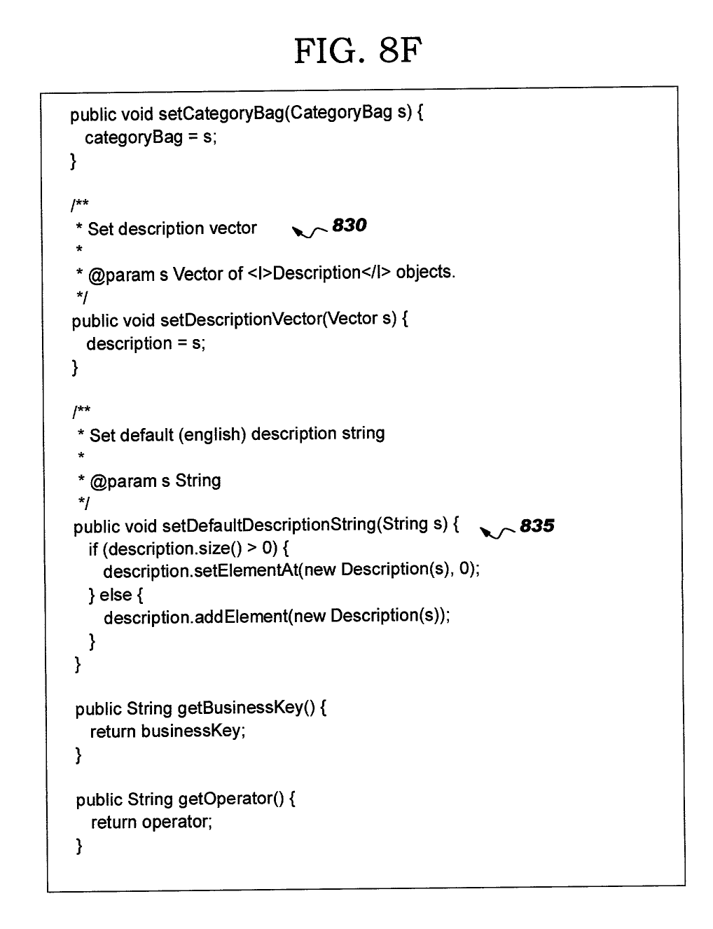

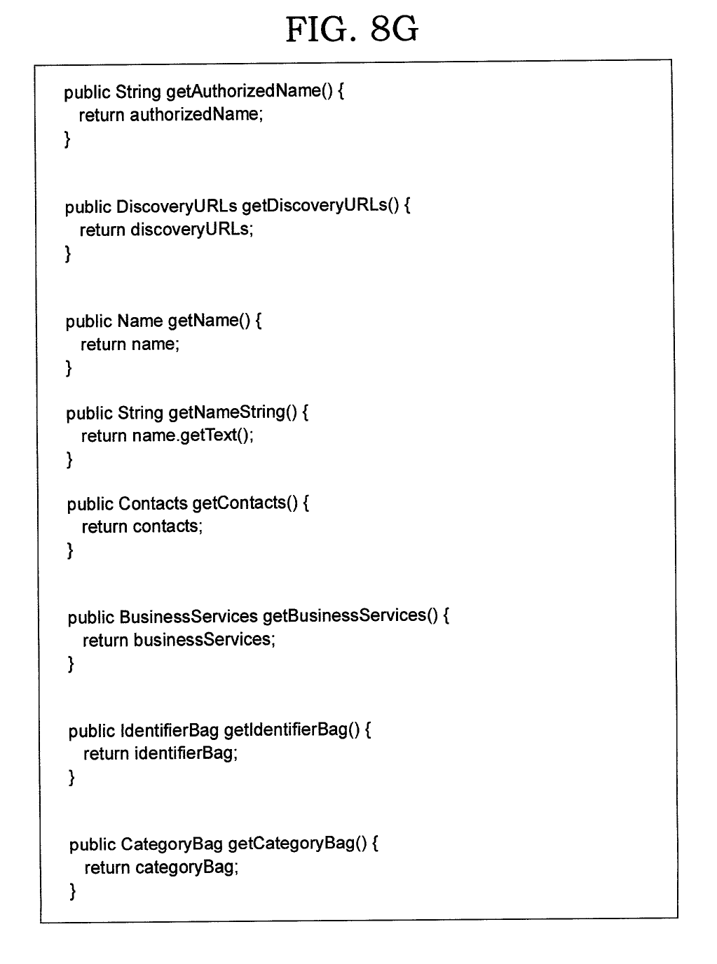

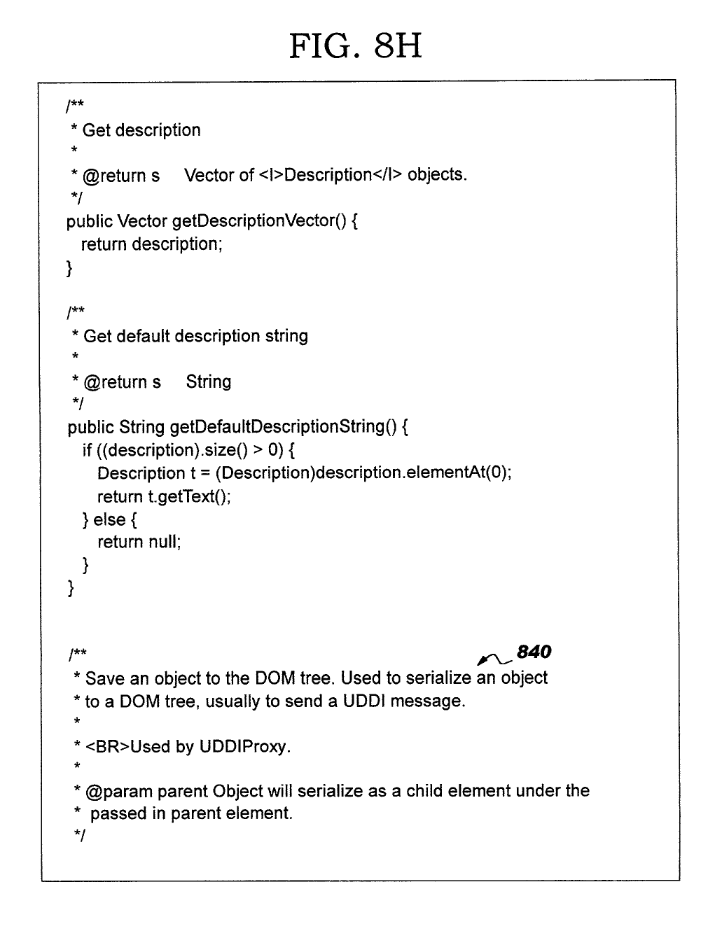

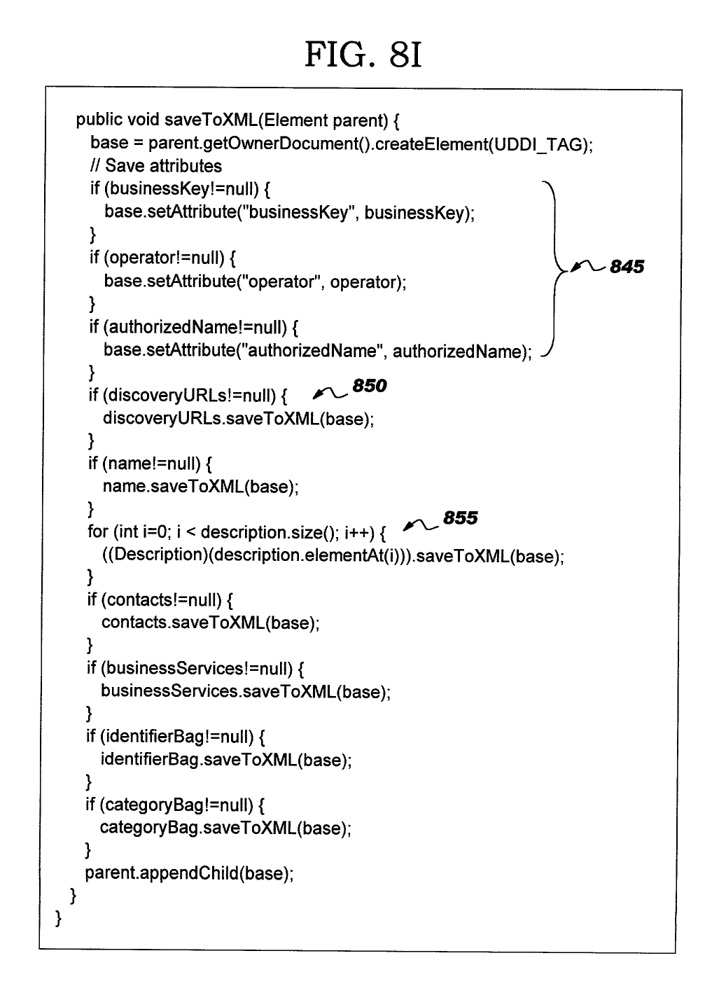

FIG. 3 illustrates a set of sample generation rules 300 that may be used with the present invention. As shown therein, the rules enable a person such as a program developer to specify the output directory into which the generated code should be placed (see element 310, where the“.” symbol indicates use of the current directory); a comment (see element 320) which the generator is adapted for placing into the generated output file (as shown at element 410 of FIG. 4A and element 805 of FIG. 8A); a pair of variables that may be used to override default behavior, in favor of particular class-specific behavior (see elements 330 and 340, specifying overrides for the “FindQualifier” class and illustrating how class-specific alterations such as inserting additional code into the generated code only for the specified class(es) can be accomplished through overriding the template code); a setting for a class-specific “dontGenerate” flag, which may be used to tell the generator to suppress generation of a particular class (see element 350, specifying that code for a “DispositionReport” class should not be generated); and a package name which the developer wishes to be used when the generator creates the code for a particular class (see element 360, specifying a package name of “com.ibm.util” for the DiscoveryURL class). With reference to the suppression flag illustrated at 350, this approach may prove beneficial when it is felt that it would be advantageous to manually create the code for a particular class.

As will be obvious to one of ordinary skill in the art, the types of rules illustrated in FIG. 3 are merely illustrative of those that may be useful for tailoring operation of the class library generator for a particular implementation of the present invention: additional or different rules may be used without deviating from the inventive concepts disclosed herein. (For example, the file name to be used for storing the class library might be specified.) Or, use of such rules may be omitted entirely, and the generation process may be tailored in other ways (such as by prompting a user for input, specifying appropriate conditional logic in the generator, reading information from a configuration file, and so forth).

FIGS. 4A and 4B show a sample class file fragment 400 resulting from using the input XML schema 200 in FIG. 2, along with the sample rules 300 in FIG. 3, as input to the generation process of the present invention. The items in this generated class will now be described, to illustrate how the present invention works to generate code for the discoveryURL element specified in the schema. First, the user-supplied package name “com.ibm.util” (element 360 of FIG. 3) has been adopted as the name of the generated package, as shown as 405. (Preferably, this value is also used to generate the path name of the output file where the generated code will be stored.) The user-supplied commentary information 320 from the rules file has been inserted into the output fragment 400 (see element 410), and the element name 210 from the schema 200 has been used as the generated class name (see element 415).

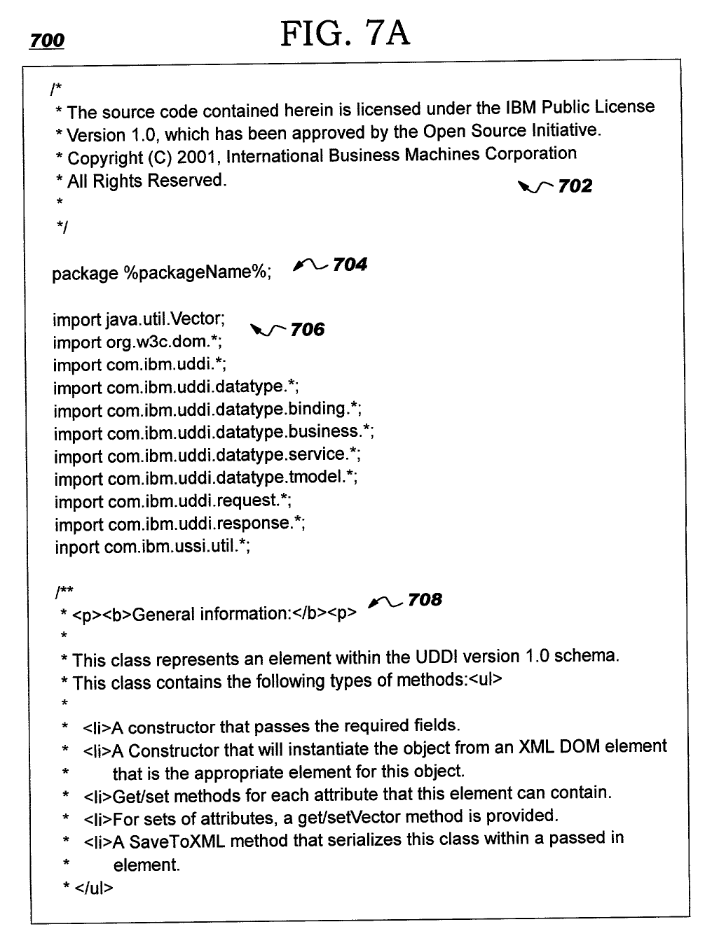

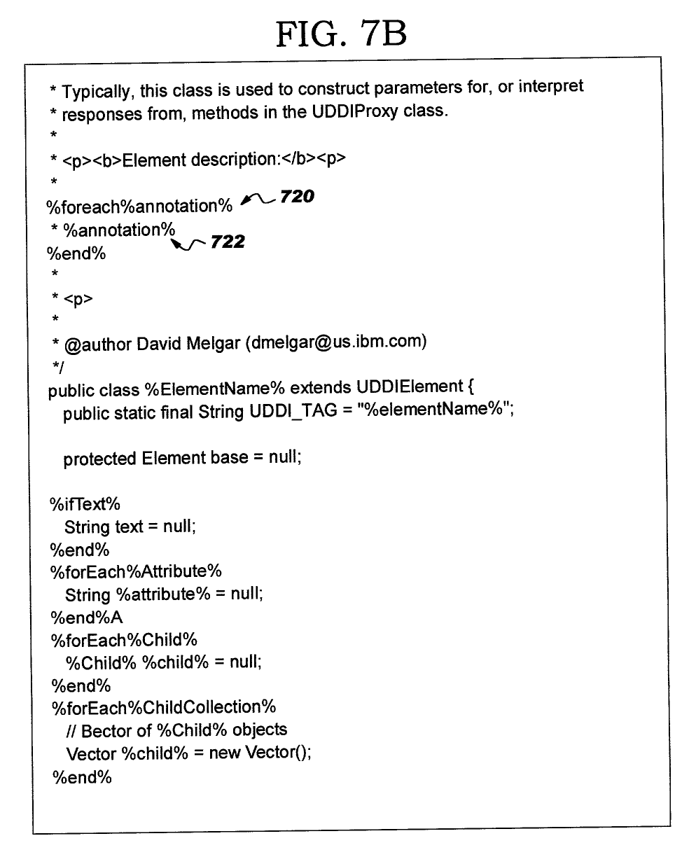

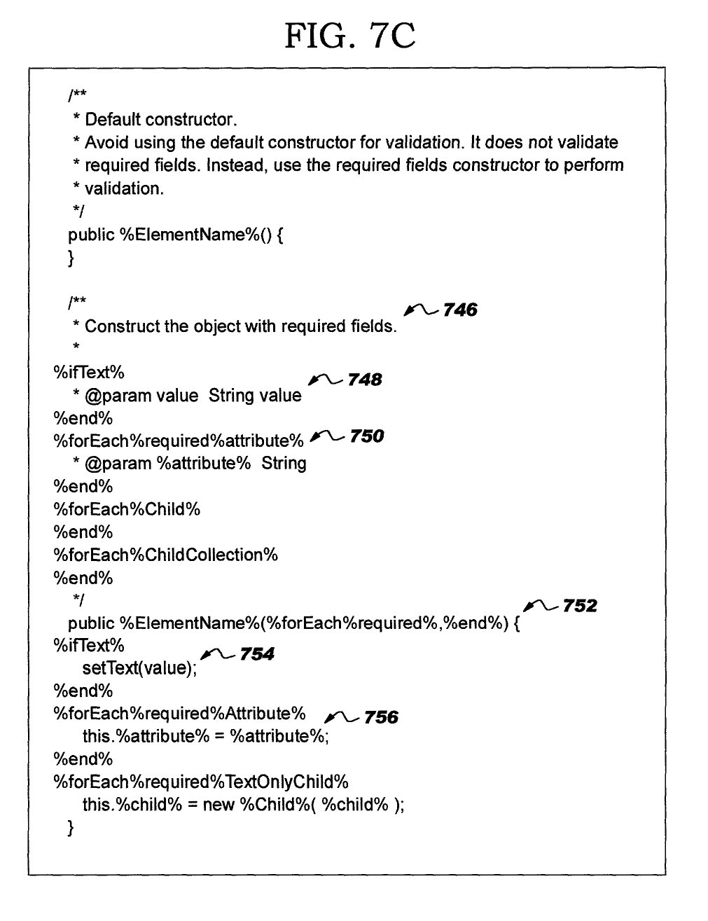

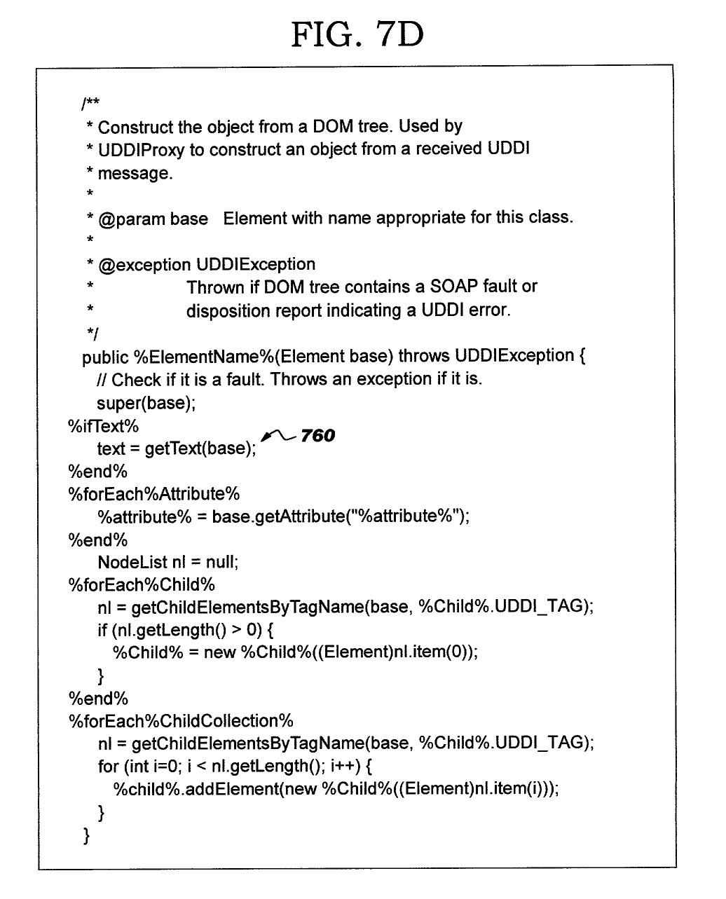

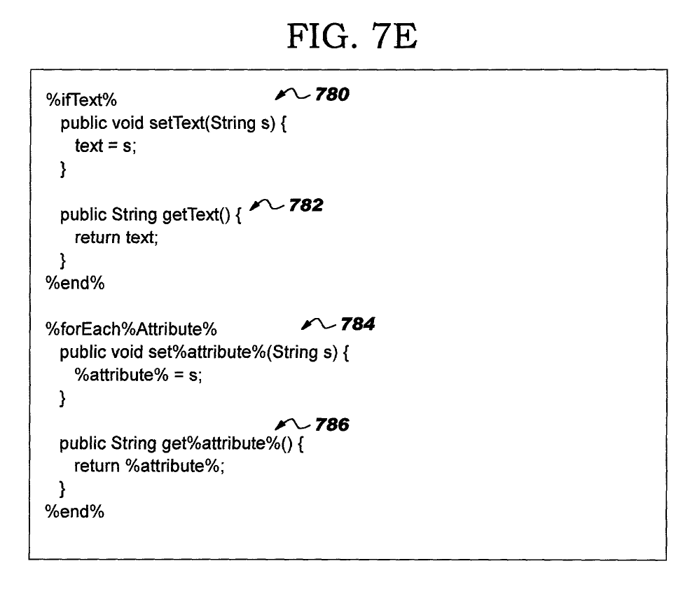

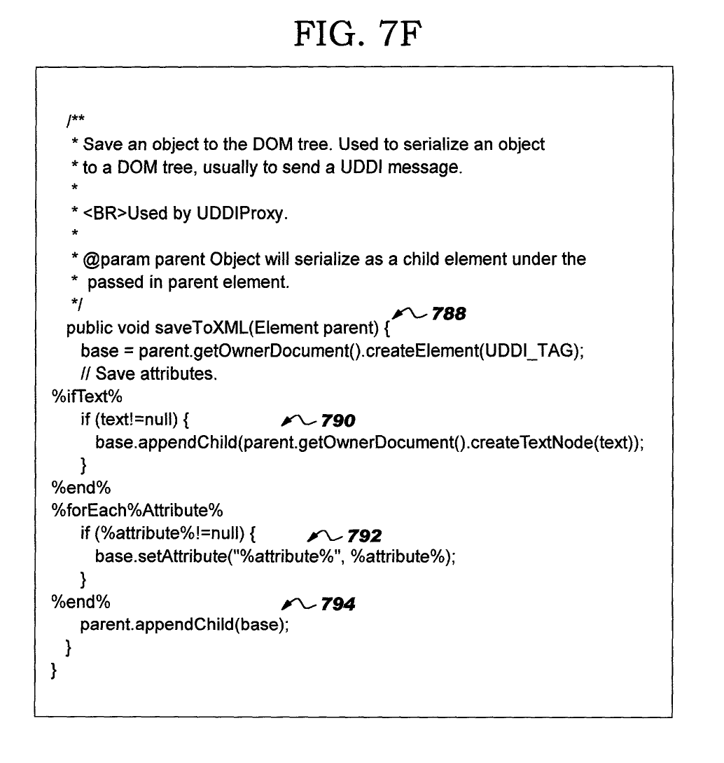

The next item in the generated class is a variable initialization 420, setting a variable “text” to null. In the example illustrated in the figures, this variable is used in all generated classes for those XML elements for which textual content is permitted. Refer to element 220 of FIG. 2, where the “textOnly” attribute is specified for the DiscoveryURL element. (Preferably, insertion of this code in all generated class libraries happens under control of a template, which will be described herein with reference to the sample template in FIGS. 7A through 7F. Or, as stated earlier, the generator may alternatively be adapted to incorporate the functions which are described herein as pertaining to such a template.) Then, an initialization statement has been generated for the “useType” attribute (element 230 of FIG. 2), setting it to null as well.

Appearing after the variable initializations is a declaration 430 of the class constructor method, “DiscoveryURL”, which will create an object at run-time that is an instance of the DiscoveryURL class. Another class constructor method is specified in the generated code at 450, after being introduced with commentary 435 (which results, in the example, from identical commentary in the template pattern 700 from which this code may be generated; see element 746 of FIG. 7C) and commentary for two parameter patterns 440, 445 (i.e. Javadoc format comments). The first parameter pattern 440 results, in the example, from the template. See element 748 of FIG. 7C, where this parameter pattern is coded as being applicable to elements which have textual content (as is the case for the discoveryURL element). The second parameter pattern 445 also results from the template, where element 750 of FIG. 7C specifies that all required attributes (of which “useType” is one) should have a parameter pattern of this form generated, in which the attribute name itself appears as the variable name.

In the signature of generated method 450, two parameters appear, where these parameters match the parameter patterns 440, 445. The method itself comprises two statements in this example. The first statement is a setter method invocation for the first parameter, and is generated under control of the template 700, which specifies at element 754 of FIG. 7C that elements allowing text should include this setter method. The second statement in method 450 initializes a property of the current object (i.e. the discoveryURL object which is instantiated by the constructor method 450) to the value of the useType attribute. The syntax shown at element 756 of the template causes this second statement to be generated in this form for each required attribute, where the actual attribute name is substituted for the placeholder syntax “%attribute%”.

Another constructor is defined in 465 that builds an object to correspond to a Document Object Model, or “DOM”, tree representation of the schema element. As is well known in the art, DOM trees are created by XML parsers to represent the tree structure of an XML element and its descendant elements. In order to use an object-oriented programming language to send and receives messages which correspond to elements defined in an XML schema, the present invention creates code for building an object corresponding to the element to be sent or received, where the element definition is stored using a DOM tree. This method 465 is preceded by a generated comment 455 and two generated parameter comments 460, according to a template which may be used in the generation process.

The object constructor is generated such that it has the same name as the XML schema element (see element 465), according to the template. The statements in this method include a getter method, because the XML schema element is a textual element (see the “%ifText%” syntax at element 760 in FIG. 7D of the template), and a statement to populate the attribute value, where the attribute's name is programmatically inserted. The template patterns shown in FIG. 7D may be used to generate the syntax of the object-constructing code shown as elements 455 through 465 of FIG. 4A. This method may be used at run-time to construct an object from a message that has been received.

In FIG. 4B, element 470 illustrates the first of two methods, a setter and a getter, which are programmatically generated because the XML schema element is a text element (according to elements 780 and 782 of the template, as shown in FIG. 7E). Next, element 475 illustrates a pair of setter and getter methods which are generated for the attribute of the XML schema element, according to the template elements at 784 and 786.

Finally, the generated code ends, as shown beginning at element 480 of FIG. 4B, with a method which saves (i.e. serializes) the object to the DOM tree. This method may be used at run-time to set values in a message to be sent. The template pattern in FIG. 7F may be used for creating this method, and as shown therein, specifies that a statement which appends a child to the current DOM tree node should be generated if this is a textual element (see element 790 of the template), and that an attribute-setting statement should be generated for each required attribute of the XML schema element (see element 792 of the template), followed by the final append child statement (see element 794 of the template).

In summary, as can be seen by review of the generated code in FIGS. 4A and 4B, this code will construct and populate an object which corresponds to the element from the XML schema; set its properties, and get its properties; prepare a corresponding DOM tree for sending a message; and retrieve a received message from the DOM tree.

Once the class library has been programmatically generated using the techniques of the present invention, it is preferably made available to a program developer through a toolkit of some type (which may, for example, enable the programmer to use drag and drop operations or a similar paradigm for inserting method invocations and so forth into his program). Alternatively, the necessary information from the class library can be made available to the program developer in other ways. (For example, the programmer might simply have a printed copy of the class library, from which he can determine the necessary syntax of method invocations.)

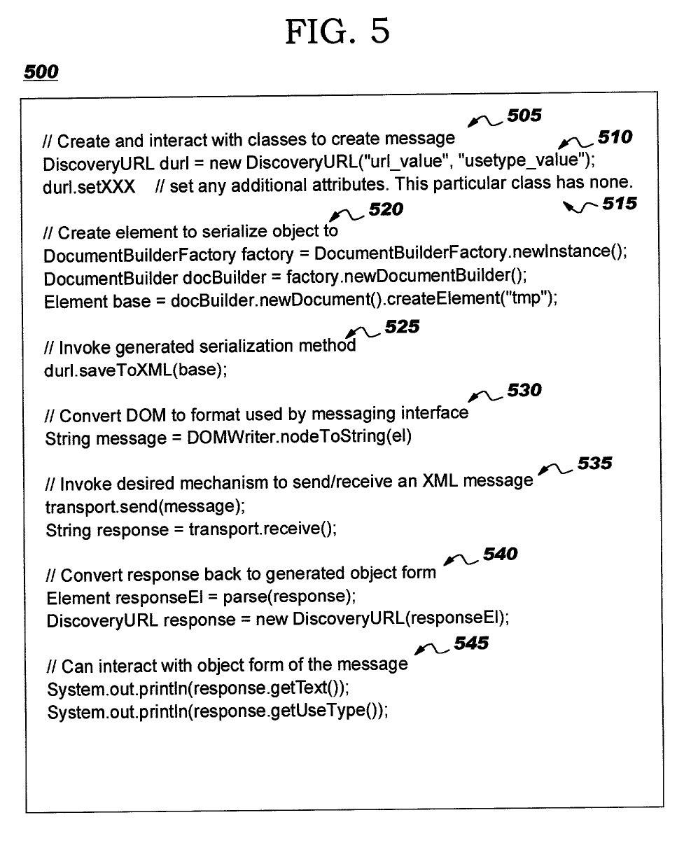

FIG. 5 shows a code fragment from a program, illustrating how the class library in FIGS. 4A and 4B may be used to send and receive messages within an application program. (Note that this code in FIG. 5 is not generated by the present invention, but is created by the programmer to make use of the code in the generated class library.) The code shown generally at element 505 of FIG. 5 creates a new instance of an object which corresponds to the XML schema element of interest (so that, for example, this object can be used for sending messages). Note that the “url_value” and “usetype_value” elements in statement 510 are placeholders, into which the programmer will place the real value for the URL and use type that are to be used with a particular message. Statement 515 is included in the example to indicate that generated classes may include additional attributes not specified on the constructor, if these attributes are not required to be set by the schema definition for this element. These optional attributes can be set individually after constructing the object. Statement 515 thus represents a setter method invocation for some optional attribute “XXX”.

The program code shown at 520 invokes document-building methods in preparation for creating a message that is to be sent, and the code shown at 525 invokes a generated method to save information from this document to the DOM. The code at 530 invokes a method of the prior art, which converts the information stored in DOM node format into a text string format that is assigned to the variable “message”. The methods at 535 may then be invoked, and first send the contents of the “message ” variable as a message and then receive a response to that sent message and store this as the value of the variable “response”. The code statements at 540 parse the received response message, and use the information thus obtained to create and populate a new instance of an object corresponding to the XML schema element of interest. Finally, the code statements at 545 are included to illustrate that the objects which have been constructed using the programmatically-generated class library can also be operated upon as normal objects. (In particular, these statements print out the text of the response message and its use type, respectively.)

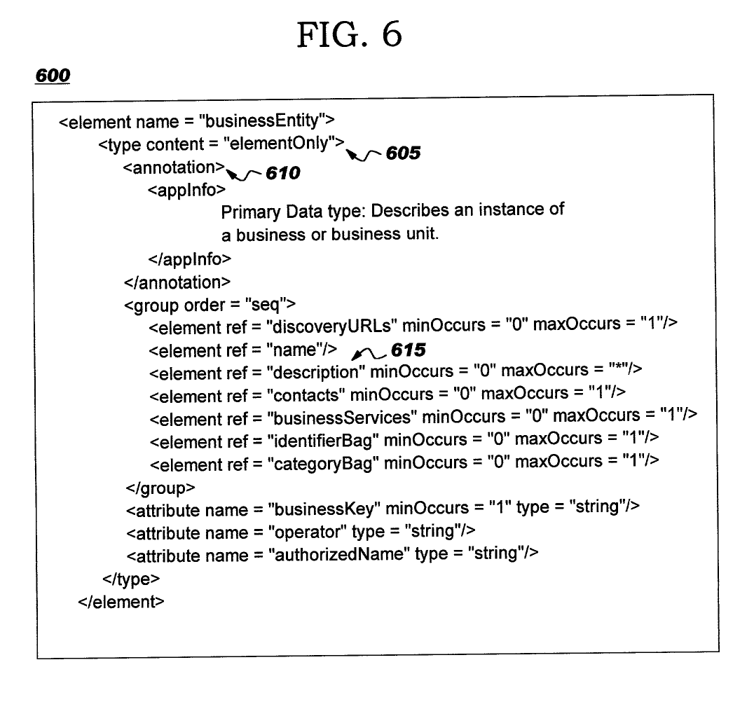

FIG. 6 presents a second sample schema fragment 600, where this sample is chosen to illustrate more complex features than the sample fragment in FIG. 2. As can be seen by inspection, the “businessEntity” element defined in this schema includes a sequential group of child elements, some of which are required and some of which are optional, and has three attributes (all of which are required). Note that the content type of this element is “elementOnly” (see the content type at 605), in contrast to the “textOnly” element of FIG. 2, and thus the “ifText” control tags within the template are not used when generating the class library for this “businessEntity” schema element.

The template concept will now be discussed in further detail, to illustrate how the template-driven approach of preferred embodiments preferably operates. A template is intended to guide the generation process in language-specific ways, as stated earlier. For example, the template in FIGS. 7A through 7F is adapted for generating code in the Java programming language, another template might be developed which creates code for the discoveryURL schema element of FIG. 2 according to nuances of some other programming language. Therefore, the templates used by preferred embodiments are constructed as a general image of the code to be generated. Tags are used within the template code to drive the operation of the generator. In the examples, the template tag syntax has the form “%xxx%”, where “xxx” is replaced by some keyword that indicates some particular behavior to be performed by the generator. For example, the “%attribute%” tag, which has been mentioned with reference to FIGS. 4A and 4B, signals to the generator that the name of an attribute should be substituted into the generated code in place of this tag.

A number of special tags which are illustrated in the sample template of FIGS. 7A through 7F are listed below, along with a description of how the generator of preferred embodiments should respond when detecting this tag in the template:

%elementName%: The generator substitutes the XML schema element name being processed. (Note that a tag name may be expressed in upper case to indicate that the replacement value should begin with a capitalized letter.)

%attribute%: The generator substitutes the name of an attribute.

%child%: The generator substitutes the name of the appropriate child, depending on the context (that is, if this special tag appears within a %forEachAttribute% tag, then the child is an attribute).

%annotation%: The generator substitutes a comment for this element from the schema.

%packageName%: The generator uses the value from the rules file for this element (see, for example, element 360 of FIG. 3).

Preferably, templates also support use of control tags that allow repetition of code. Each such control tag begins a code block in the template, which ends with an %end% tag. Examples of control tags that may be beneficially used, along with an explanation of their meaning, are listed below:

%forEach%Attribute%: The block of template code within the scope of this tag (i.e. until reaching its corresponding end tag) is repeated for each attribute, with each attribute name substituted for any intervening %attribute% tags.

%ifText%: The block is evaluated/used if the element being processed allows text.

%forEach%Child%: The block is used for each child element, of which there can only be one, with the appropriate child information substituted for intervening “%child%” tags.

%forEach%ChildCollection%: The block is repeated for each child element, which allows multiples, i.e. collections, with the appropriate child information substituted for intervening “%child%” tags.

%forEach%TextOnlyChild%: The block is repeated for each child element that is text only, i.e. has no attributes or children of its own.

%required%: This tag can be inserted between forEach and Child or Attribute to indicate special behavior. That is, a %forEach %required %Attribute%” tag indicates that the following behavior is to be evaluated for each of the required attributes of the current XML schema element.

As will be obvious, these tags are merely illustrative, and additional and/or different tags, or different tag syntax or delimiter syntax, may be used if desired. Furthermore, note that the tag syntax described above can be changed if it conflicts with a desired target language.

A number of the tags used in the sample template 700 have already been discussed with reference to the simple schema fragment in FIG. 2 and the corresponding class library in FIGS. 4A and 4B. Several other constructs used in the sample template will now be described. Introductory comments 702, which in the example specife sample licensing and copyright information, may be included. The generator is preferably adapted to transfer any comments from the template directly into each generated class library. A package name statement 704 is also included, which contains a placeholder into which the actual package name will be programmatically inserted by the generator. (According to preferred embodiments, the value to be substituted comes from a set of rules as illustrated in FIG. 3, although as has been described, other approaches may be used as well.) Next, a set of import statements beginning at element 706 may be specified; the generator is preferably adapted to transfer these statements directly to the generated class library. An optional block of comments appear next, as shown at 708. As stated above, the generator preferably copies all comments into the generated class library.

Note that the sample class library in FIGS. 4A and 4B does not contain a counterpart to the template statements at elements 702 and 704, and contains only part of the statements at element 708. It may therefore be assumed that the template which was used for creating that class library differed from the portion of template 700 that is shown in FIG. 7A. The more complex sample class library in FIGS. 8A through 8I, on the other hand, does include these elements (see FIG. 8A), and thus it may be assumed that the template used in generating the more complex sample class library included these elements shown in FIG. 7A.

Referring to FIG. 7B where the template continues, element 720 is representative of the control tags which may be used to repetitively generate output code. This “%foreach%annotation%” element 720 specifies that the embedded statement 722 is to be repeated for each annotation, where the commented “%annotation%” statement 722 specifies that the annotation located in the XML schema element is to be inserted (as commentary) into the class library output. See element 810 in FIG. 8B, where the annotation 610 from the schema element in FIG. 6 has been copied (as a comment statement).

The remaining template content shown in FIGS. 7C through 7F uses the same approach as has been discussed, whereby special tags delimited by “%” as well as control tags are used as described above, and whereby commented code and other code which is not delimited (see, for example, the statements at element 788 of FIG. 7F) are copied directly into the generated output code.

Reference is now made to the generated class library in FIGS. 8A through 8I, which corresponds to the schema fragment 600 of FIG. 6. Some parts of the generated class library correspond to the sample template 700; others, several of which will be briefly described, do not. Sample class library 800 is provided to illustrate a number of more complex aspects that may be handled by a code generator created according to the present invention. (It may be assumed that a slightly different template was used for creating the class library 800, differing in those several areas from the template 700. For example, where additional commentary is present in the class library 800, it may be presumed that additional comments were present in the template. It is not deemed useful to duplicate large amounts of commentary between the sample template 700 and the sample output 800, and such minor variations should be easily recognizable upon inspection of any differences between template 700 and sample output 800. It will be obvious to one of ordinary skill in the art how extensions to the sample template can be created, once the teachings disclosed herein are known.)

Element 815 in FIG. 8B, for example, shows more complex variable generation, wherein an assignment statement has been generated for each of the three attributes of the XML schema element 600 of FIG. 6, as well as for a number of the elements defined therein for the <group> tag. Note that the “description” element 615, which is optional and may appear multiple times, has a corresponding assignment statement 820 in which it is treated as a vector. (Note also that the sample template does not illustrate syntax corresponding to the generated code at 815. As will be obvious, the sample template may be extended or altered to adapt to the needs of a particular implementation and the schema objects to be processed, and the generated code at 815 is one example of a possible extension.)

Element 825, comprising all of FIG. 8D, also provides an example of more complex processing that may optionally be handled in a template. Here, the constructor method has been replaced with a more complex type of constructor, due to the various element types of the corresponding schema element 600.

The setter and getter methods shown in FIGS. 8E and 8G, respectively, highlight the previously-discussed problem whereby manual generation of class library code tends to be error-prone because of its redundant nature. Although many such methods may need to be generated for a particular schema, they differ only slightly. Thus, the generation task will tend to be more accurate if performed programmatically, as when using the present invention. (As stated above with reference to FIG. 4B, the setters are getters are generated in response to template code such as that illustrated by elements 780, 782, 784, and 786 of FIG. 7E.)

Elements 830 and 835 in FIG. 8F illustrate code that may be generated to handle vectors (that is, elements which may appear multiple times, according to the schema definition). These elements correspond to “description” 615. Element 830 sets the vector to an input value, and element 835 shows conditional logic that may be generated from a template. (Note that the actual template which generates the code shown at 830 and 835 will have “%attribute%” tags which cause the text “description” to be generated in the places where it appears in elements 830 and 835. The sample template 700 has not been extended to cover these cases, but it will be obvious to one of ordinary skill in the art how such extensions can be created.)

The serialization method which begins at 840 of FIG. 8H and continues through the end of FIG. 8I illustrates a more complex serialization approach than that illustrated in FIGS. 4A and 4B, and contains code to handle various types of supported element relationships as required for the sample schema fragment in FIG. 6. This serialization method is another part of the output class library where the generated code shown in the example extends beyond what is represented by the template code. For example, the commentary at 840 of FIG. 8H matches the template commentary in FIG. 7F, and the generated “saveToXML” method signature in FIG. 8I matches the template code at 788; in addition, the three setter methods shown generally at element 845 of FIG. 8I match the pattern for attribute getter methods which is specified at element 792 of FIG. 7F. However, the template does not include extensions to support the “saveToXml” method generation for child elements which corresponding to the group defined in FIG. 6, such as the methods shown at 850 and 855 in FIG. 8I. (Again, it will be obvious from the examples how such extensions to the template can be created.)

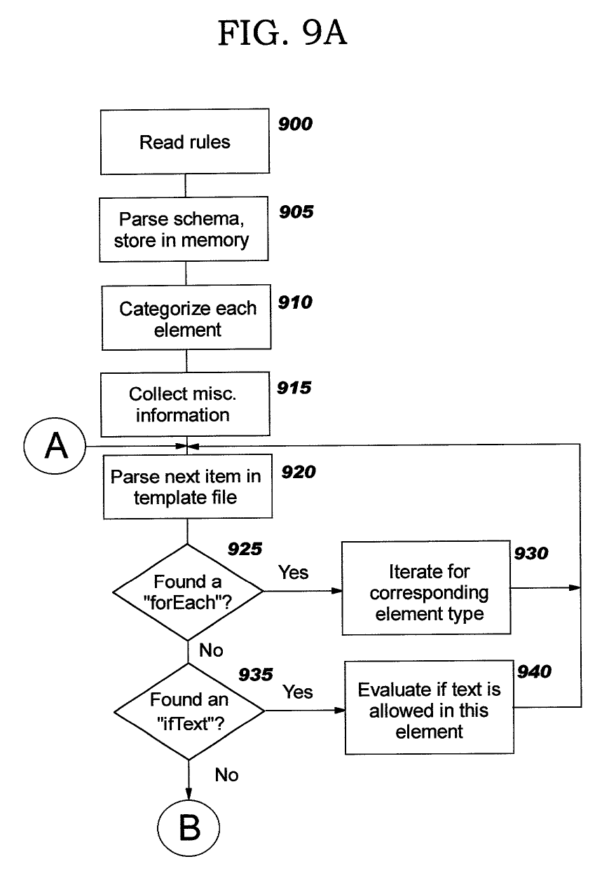

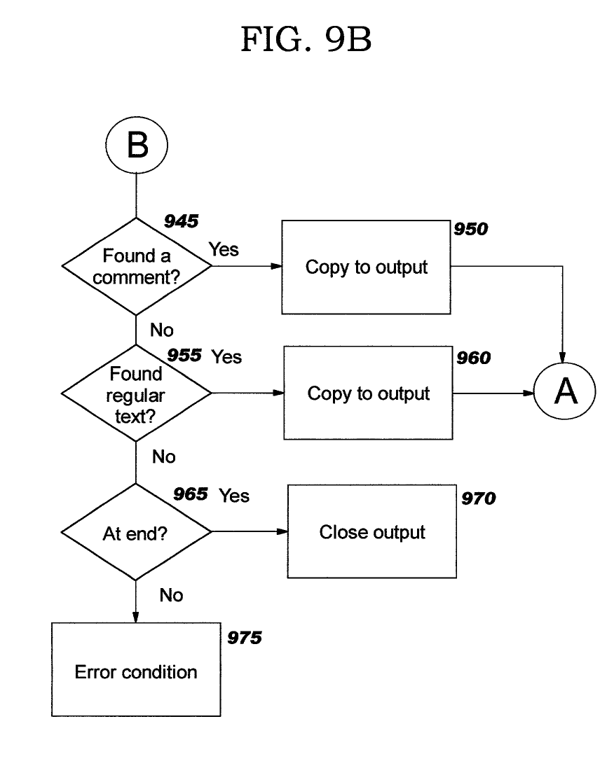

Reference is now made to FIGS. 9A and 9B, in which flowcharts are provided depicting logic that may be used to implement preferred embodiments of the class library code generation process of the present invention. This process begins at Block 900, where the rules file is read. (Depending on how a rules file is used in a particular implementation, its contents may affect various parts of the generation process. With reference to FIGS. 9A and 9B, the rules input is preferably used, inter alia, to control where the output files are stored during the code generation process in Blocks 930, 940, 950, and 960. For example, the path prefix to be used for the output file was described earlier with reference to element 310 of FIG. 3.)

As indicated by Block 905, the input schema which represents the message formats of interest is parsed and is preferably stored in memory. Each parsed element is preferably categorized (Block 910) during the parsing process. This categorization comprises determining the element type, and associating that type information with the element name (in a table or other type of storage structure, preferably). Example categories include: a simple text element which does not allow children; an element allowing a single instance of a child element; and an element which contains a set of child elements (and any sequence restrictions on those child is preferably remembered as well). Relationships among elements are remembered, such as which element is a child of another element. Cardinality information for child (i.e. nested) elements is preferably remembered, which may be one of: required; optional; single; or multiple.

Other types of information may also be collected during the parsing, as indicated by Block 915. Examples include annotations (that is, comments which are associated with elements from the schema, as illustrated by the sample annotation 610 of FIG. 6); attributes within an element (including whether or not the attribute is required); and so forth.

At Block 920, the generation process begins by reading through the template. As each template element is located, relevant substitutions are performed by iterating through the remainder of the logic in FIGS. 9A and 9B, beginning at Block 925. Properties from the rules file read at Block 900 may be used to customize this behavior, as stated above.

For the item (e.g. a token or statement of code, as appropriate) which was located by Block 920, the test in Block 925 asks if this item is a “forEach” tag. If not, then processing continues at Block 935. Otherwise, Block 930 iterates through the scope of the “forEach” syntax (i.e. to its corresponding “end” tag), applying the processing specified by its included tags to each instance of the corresponding element type. For example, if this is a “for each attribute” case, then processing loops through the attributes which were located in the schema during the parsing and categorization process, and the logic included in the scope of the “for each” tag is applied to each attribute. Or, if this “for each attribute” tag is qualified as being applicable only to the required attributes, then only the required attributes are processed when applying the processing specified in the template. Elements that can be contained within the current element only once (i.e. a child element), as well as elements that can be contained within this element multiple times (i.e. a child collection), are also preferably processed in this manner when directed by an appropriate “for each” tag. Any substitutions indicated in the template logic are performed, and the resulting code is written to the output file. After processing is finished for the indicated element type, control returns to Block 920 to parse the next item from the template file.

Block 935 is reached when the parsed element in the template file was not a “for each” tag. Block 935 checks to see if it was an “if text” tag. If so, then Block 940 loops through each element of the schema to determine whether text is allowed in the element. (Preferably, this has been determined during the previously-performed parsing and categorization processing, and thus Block 940 merely needs to consult a stored flag or variable of some type.) If text is allowed, then the logic included in the scope of the “if text” tag is processed for the element. Any substitutions indicated in the template logic are performed during this processing, and the resulting code is written to the output file. Otherwise, when an element does not allow text, the logic within the “if text” scope is treated as non-operative. Once all the elements have been processed for this “if text” tag, control returns from Block 940 to Block 920 to continue parsing the template file.

Continuing on to FIG. 9B, if the parsed item from the template was not an “if text” tag, Block 945 checks to see if it is a comment. If so, then Block 950 copies the comment directly into the output file (making any substitutions that might be indicated by placeholder tag syntax, such as by substituting attribute names in place of “%attribute%” tags.). Otherwise, when it was not a comment, Block 955 checks to see if the item is “regular” text (such as element 788 of FIG. 7F, which was discussed earlier). If so, then Block 955 copies the regular text directly into the output file (again making any substitutions that might be indicated by placeholder tag syntax). Following completion of Block 950 or 960, control returns to Block 920 of FIG. 9A to continue parsing the template file.

When the test in Block 955 has a negative result, processing reaches Block 965, which checks to see if this is the end of the template file. If so, then the output file is closed (Block 970), and the processing of FIGS. 9A and 9B ends. Otherwise, the parsed element does not match any of the expected cases, and this is an error, as reflected in Block 975. An error message may be generated, and the processing of FIGS. 9A and 9B is preferably halted.

The algorithm illustrated in FIGS. 9A and 9B may be extended with additional constraint types, as the need arises. Furthermore, it should be noted that the order of the blocks may be altered without deviating from the scope of the present invention. In addition, while preferred embodiments as illustrated herein read a schema, parse the schema into a DOM, and store information about each element in this process, alternative embodiments may use other approaches (such as using the DOM representation directly, rather than as an intermediate step), and such alternatives are considered to be within the scope of the present invention.

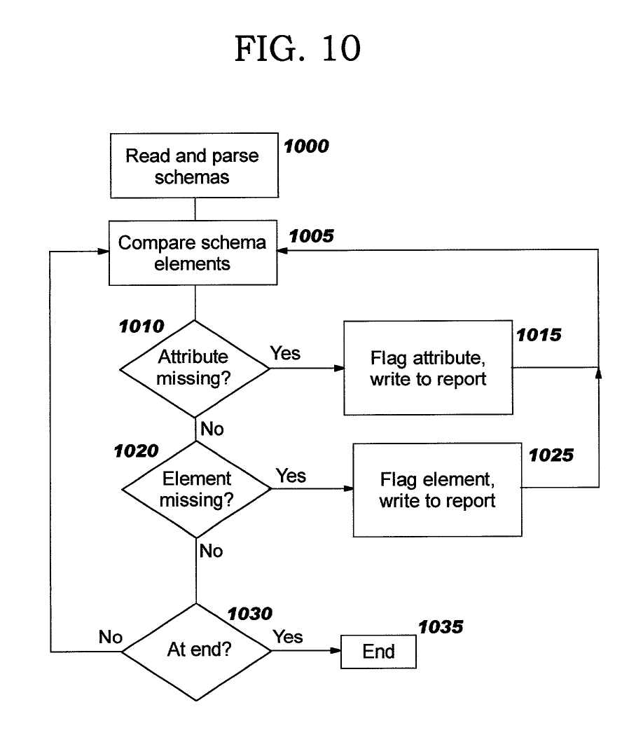

In an optional aspect, the present invention may be adapted for use with migration logic (which may be referred to alternatively as “versioning” logic), as stated earlier. For this aspect, the generator is preferably extended to read in multiple schemas, where these schemas will be compared to determine revisions and handle evolution of the message specification which they represent. As a schema changes over time, there may be programs which are written for an earlier interface; typically, it is desirable to maintain support for older versions for some period of time while also supporting a newer version. This aspect therefore enables programmatically identifying changes in versions of a schema, and with input from a user to specify template modifications (as will be described below), the generator can then be re-executed in order to programmatically regenerate a class library which includes code for both versions (as reflected in the template). The schema comparison operation of this aspect is represented by the logic of the flowchart in FIG. 10.

As shown in FIG. 10, the migration processing begins by reading and parsing the two schemas that are to be compared (Block 1000). An internal database is preferably populated, for each schema. The schemas are then compared (Block 1005), element by element and attribute by attribute. If any attribute from the old schema no longer exists in the new schema, then the test in Block 1010 has a positive result, and control transfers to Block 1015 which flags that attribute and preferably writes the attribute's information (such as its name, its old syntax, and so forth) to a report. Control then returns to Block 1005 to continue comparing schema elements.

Block 1020 detects the case where an element, rather than an attribute, no longer exists in the newer schema. The processing for a missing element (Block 1025) is similar to that described above for a missing attribute. That is, such elements are preferably flagged and information written to a report. Control then returns to Block 1005.

If neither an attribute nor an element is missing from the newer schema, and the comparison is not yet complete (as determined in Block 1030), processing returns to Block 1005; otherwise, when the comparison is finished, then the processing of FIG. 10 ends (as indicated by Block 1035).

When completed, the report which is prepared according to Blocks 1015 and 1025 is preferably manually edited by the user to provide conversion logic, which in preferred embodiments is preferably added to a migration template. (Alternatively, this conversion logic might perhaps be handled by specifying a rule in a rules file or by adding logic to the generator. The nature and complexity of the change may be factors in determining how best to handle it.)

For each attribute identified on the report, the user preferably indicates the status of that “missing” attribute, and will then use this information to determine how to modify the migration template. The status may include: (1) the attribute has been renamed; (2) the attribute has been removed; or (3) the attribute has been moved to a containing element (i.e. it has changed cardinality). In case (1), the user preferably specifies conversion logic in the migration template that will enable the class library to generate code for the attribute using its new name as well as by using the old name. The class library will then contain code that is able to process both versions of this attribute from the evolving message specification. In case (2), code may be added to the template to deprecate the method(s) corresponding to this attribute (e.g. the setter and getter methods). For example, code for these methods might be augmented to generate an exception report or an error condition, notifying the caller that the attribute has been removed. Or, code may be added to generate a comment in the class library, indicating that the old attribute has been removed, thus reminding program developers not to use this attribute in the future. In case (3), if the attribute was originally a singleton but has now become a collection, the generator can be adapted such that it will produce code to maintain the earlier singleton method and at the same time, populate a specific item in the collection (e.g. the first item) with the value received when the singleton method is invoked. Methods for the new collection will be generated as well, to support the new interface. The generator can attempt to discover this type of change (i.e. case 3) itself, by searching for the attribute within elements contained within a parent element. (Optionally, the user might specify the element and its attribute name in a rule, as the type of element-specific rule processing which was discussed earlier with reference to FIG. 3.)

For each element identified on the report, the user preferably specifies logic in the template to tell the generator how to handle that missing element. Options for handling the missing element include: (1) if the element has been renamed, then the user preferably specifies conversion logic that will enable the class library to include code for the element using its new name as well as its old name; and (2) if the element has been removed, then the generator is preferably instructed to deprecate the class corresponding to this element, as well as all references to its methods from other classes, in the manner described above for handling removed attributes.

(Note that while discussions herein are in terms of a user analyzing the generated report and specifying logic to account for changes identified therein, this is for purposes of illustration only. A programmatic analysis and modification technique could be developed alternatively, and is considered as being within the scope of this aspect of the present invention.)

Obviously, any attributes and elements that are added to a newer version of a schema will be automatically handled during the re-generation of the class library, and therefore it is not necessary to account for added attributes and elements during the processing of FIG. 10. (Optionally, the appearance of the new attributes and elements could be documented on the report, if desired.)

Optionally, a Javadoc (or a separate document) can be produced that lists the changes between the versions of the schema. The document preferably lists classes and methods removed, new classes and methods added, and methods that have changed due to differences in cardinality. This documentation is typically very difficult and error-prone to write manually. The programmatic techniques of this optional aspect therefore provide a very valuable documentation tool during the migration process as well.

As has been demonstrated, the present invention provides advantageous techniques for programmatically generating class libraries to represent specifications provided in structured language definitions. The disclosed techniques are very flexible, and are not limited to a single output programming language as is the case for prior art generators. The generation process can be directed by templates and/or rules. The disclosed techniques can also be used to generate class libraries for web services which have a service interface defined using only a schema reference, again providing significant advantages over prior art approaches. Migration can be evaluated programmatically, enabling much easier resolution of migration issues than is possible using prior art manual migration techniques.

A company named “The Breeze Factor” produces a development tool to help develop Java classes based on XML schema. Their approach appears, to the best of the present inventor's knowledge and belief, to generate output in a specific, fixed format and does not allow generating code for multiple programming languages nor use of templates. Other class library generators may exist in the prior art which generate their output based on a schema; however, it is believed that no prior art generators exist which provide the flexible, multi-language approach of the present invention nor the type of WSDL support or template support provided by the present invention.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of programmatically generating a class library to represent messages described in a structured language specification, comprising steps of
parsing an input structured language specification encoded in a structured markup language;
identifying selected aspects of the input structured language specification during the parsing step; and
creating output code for the identified selected aspects by applying previously-specified operations, wherein the previously-specified operations create programming language statements in a target programming language such that the created output code comprises a class library in the target programming language.

2. The method according to claim 1, wherein the input structured language specification is a schema.

3. The method according to claim 1, wherein the input structured language specification is a Document Type Definition (“DTD”).

4. The method according to claim 1, wherein the structured markup language is Extensible Markup Language (“XML”).

5. The method according to claim 1, wherein the selected aspects comprise presence of one or more of (1) elements and (2) attributes encoded in the structured markup language.

6. The method according to claim 5, wherein the selected aspects further comprise presence of child elements.

7. The method according to claim 5, wherein the selected aspects further comprise whether the attributes are required attributes.

8. The method according to claim 1, wherein the selected aspects and the previously-specified operations are specified in a template.

9. The method according to claim 8, wherein the template is adapted to creating the output code in the target programming language.

10. The method according to claim 9, further comprising the step of substituting a different template to create the output code for the input structured language specification in a different target programming language.

11. The method according to claim 1, wherein the target programming language is an object-oriented programming language, and wherein the previously-specified operations comprise creating output code for creating objects which represent elements of the input structured language specification.

12. The method according to claim 11, wherein the previously-specified operations further comprise creating output code for setting value in, and retrieving values from, the created objects.

13. The method according to claim 11, wherein the previously-specified operations further comprise creating output code for sending a message whose contents reflect one of the created objects.

14. The method according to claim 12, wherein the previously-specified operations further comprise creating output code for sending a message whose contents reflect the values retrieved from one of the created objects.

15. The method according to claim 12, wherein the previously-specified operations further comprise creating output code for receiving a message and using contents of the received message for setting the value in one of the created objects.

16. The method according to claim 1, further comprising the step of using rules to influence processing of the creating step.

17. The method according to claim 16, wherein one of the rules specifies where the created output code should be stored.

18. The method according to claim 16, wherein one of the rules specifies a name for the class library.

19. The method according to claim 16, wherein one or more of the rules specifies special processing to override the creating step for particular ones of the aspects.

20. The method according to claim 1, wherein the method is invoked during processing of a web service which is specified using a reference to the input structured language specification.

21. The method according to claim 20, wherein the reference is specified as a Uniform Resource Locator in a Web Services Definition Language document.

22. The method according to claim 8, further comprising the step of programmatically generating migration logic for the input structured language specification.

23. The method according to claim 22, wherein the step of programmatically generating migration logic further comprises steps of:
repeating the parsing step for parsing a newer version of the input structured language specification;
comparing the parsed input structured language specification to the parsed newer version;
identifying, during the comparing step, elements and attributes which are present in the input structured language specification but which are not present in the newer version; and
modifying the template to account for the identified elements and attributes; and
wherein the modified template is used by the identifying and creating steps.

24. The method according to claim 23, wherein the modifying step is performed by a human.

25. The method according to claim 23, wherein the modifying step is performed programmatically.

26. A system for programmatically generating a class library to represent messages described in a structured language specification, comprising:
means for parsing an input structured language specification encoded in a structured markup language;
means for identifying selected aspects of the input structured language specification during operation of the means for parsing; and
means for creating output code for the identified selected aspects by applying previously-specified operations, wherein the previously-specified operations create programming language statements in a target programming language such that the created output code comprises a class library in the target programming language.

27. A computer program product for programmatically generating a class library to represent messages described in a structured language specification, the computer program product embodied on one or more computer-usable media and comprising:
computer-readable program code means for parsing an input structured language specification encoded in a structured markup language;
computer-readable program code means for identifying selected aspects of the input structured language specification during operation of the computer-readable program code means for parsing; and
computer-readable program code means for creating output code for the identified selected aspects by applying previously-specified operations, wherein the previously-specified operations create programming language statements in a target programming language such that the created output code comprises a class library in the target programming language.
